(19) United States
(12) Patent Application Publication
(10) Pub. No.: US 2016/0013460 A1
(43) Pub. Date: Jan. 14, 2016

(54) SEALING STRUCTURE FOR SEALED BATTERY, AND SEALED BATTERY

(71) Applicants: SUMITOMO ELECTRIC INDUSTRIES, LTD., Osaka-shi, Osaka (JP); KOKOKU INTECH CO., LTD., Tokyo (JP)

(72) Inventors: Atsushi FUKUNAGA, Osaka-shi (JP); Mizuo IWASAKI, Osaka-shi (JP); Kazunori YAMAZAKI, Kitaadachi-gun (JP)

(21) Appl. No.: 14/772,052

(22) PCT Filed: Jan. 14, 2014
(86) PCT No.: PCT/JP2014/050465

§ 371 Date: Sep. 1, 2015

(30) Foreign Application Priority Data
Mar. 1, 2013 (JP) 2013-041103

(51) Int. Cl. H01M 2/08; H01M 10/39

(52) U.S. Cl. CPC H01M 2/08; H01M 10/399

(57) ABSTRACT

A sealing structure comprises a sealing plate having an injection hole, and a sealing plug for sealing the injection hole, and the sealing plug has a press-fitted member including an elastic material and press-fitted into the injection hole to block the injection hole, and a plate-shaped holding member for applying pressure to the press-fitted member so that the press-fitted member is held in a state of being press-fitted into the injection hole, the plate-shaped holding member being bonded to the sealing plate. The press-fitted member has a plate-shaped base which has a larger diameter than that of the injection hole and is in contact with the holding member at one principal surface, and a protruding part which is provided so as to protrude from the other principal surface of the base and is inserted into the injection hole. The diameter PD1 of the protruding part at the boundary with the base is larger than the diameter HD1 of the holding-member-side first opening of the injection hole, and the diameter PD2 at the tip portion is smaller than the diameter HD1. A gap L1 is provided between the base and the first opening of the injection hole in a state in which the injection hole is sealed by the sealing plug.

### TECHNICAL FIELD

The present invention relates to a sealing structure which a sealed battery includes, and particularly to a sealing structure in which a hole, provided in a sealing plate for sealing an opening of a battery case, for injecting an electrolyte is sealed by a sealing plug.

### BACKGROUND ART

In recent years, sealed batteries including alkali storage batteries such as a nickel-metal hydride storage battery and a nickel-cadmium storage battery, and lithium ion storage batteries, are widely used as battery power to be used for mobile devices such as a mobile phone, a portable audiovisual (AV) equipment, and a notebook computer. Further, a molten salt battery (molten salt electrolyte battery) receives attention as a sealed battery having high heat resistance and high energy density. The molten salt battery has a wide operating temperature range, for example, from room temperature to 190° C. or higher, compared with other batteries, and can be composed of a non-combustible material. Therefore, in a power-supply apparatus using the molten salt battery, spaces for heat rejection, a fire protection device and explosion-proof equipment become unnecessary. Accordingly, it becomes possible to arrange a battery in high density, and as compared to a battery pack having the same capacity, it is also possible for a power-supply apparatus using the molten salt battery to realize to have half the volume of a power-supply apparatus using a lithium ion storage battery. Accordingly, the power-supply apparatus and equipment including the power-supply apparatus can be easily downsized.

A shape of the sealed battery such as a molten salt battery is commonly cylindrical or rectangular. Particularly, a rectangular sealed battery is favorable in point of excellent space efficiency. In these sealed batteries, a cylindrical battery case made of a metallic plate houses a power generating element in which an electrode group composed of a positive electrode and a negative electrode is impregnated with an electrolyte. An opening of the battery case is sealed with a metallic sealing plate. Sealing is applied between the sealing plate and the opening of the battery case so as to prevent an electrolyte or a gas from leaking out. This sealing is often performed by a mechanical swaging method. Alternatively, in the case of the rectangular sealed battery, sealing is often performed by laser welding.

As a method of impregnating the electrode group with an electrolyte, a method in which an electrode group is put in and an electrolyte is injected into a battery case and then an opening of the battery case is sealed with a sealing plate is often employed. However, in this method, defective sealing easily occurs if the electrolyte has adhered to a welded portion in applying welding between the sealing plate and the opening of the battery case. Thus, the method is performed to provide a small injection hole of about 1 to 2 mm in diameter for injecting an electrolyte into a sealing plate (Parent Document 1).

It becomes possible to inject an electrolyte through the injection hole after welding the sealing plate to the opening of the battery case by providing such an injection hole. Consequently, it becomes possible to apply welding between the sealing plate and the opening of the battery case in a state in which the electrolyte is not yet put in the battery case, and it is possible to prevent the occurrence of defective sealing due to the electrolyte adhering to the welded portion. In addition, the injection hole can be blocked by a sealing plug formed of an elastic material such as a rubber after injecting an electrolyte (refer to Patent Document 2).

### CITATION LIST

### Patent Literature

Patent Literature 1: Japanese Unexamined Patent Publication No. 11-25936

Patent Literature 2: Japanese Unexamined Patent Publication No. 2000-268811

### SUMMARY OF INVENTION

### Technical Problem

However, in the sealing structure of the above-mentioned conventional injection hole, sometimes, it becomes a problem that sealing performance is deteriorated due to degradation of the elastic material contained in the sealing plug. When the sealed battery is a molten salt battery, it is assumed that charge-discharge is carried out in a state in which a battery is heated to a temperature of, for example, 60° C. to 100° C. In such an environment, since the degradation of the elastic material is accelerated, it is thought that sealing performance of the sealing plug is also deteriorated by prolonged use of a battery.

### Solution to Problem

An aspect of the present invention pertains to a sealing structure for sealing an injection hole through which an electrolyte is injected into the sealed battery. The sealing structure comprises a sealing plate having the injection hole, and a sealing plug for sealing the injection hole, wherein the sealing plug has a press-fitted member which includes an elastic material and is press-fitted into the injection hole to block the injection hole, and a plate-shaped holding member for applying pressure to the press-fitted member so that the press-fitted member is held in a state of being press-fitted into the injection hole, the plate-shaped holding member being bonded to the sealing plate, and wherein the press-fitted member has a plate-shaped base having a larger diameter than that of the injection hole, the plate-shaped base being in contact with the holding member at one principal surface and a protruding part provided so as to protrude from the other principal surface of the base, the protruding part being inserted into the injection hole; the diameter PD1 of the protruding part at the boundary with the base is greater than the diameter HD1 of the holding-member-side first opening of the injection hole, and the diameter PD2 of the protruding part at the tip portion is less than the diameter HD1; and a gap L1 is provided between the base and the first opening of the injection hole in a state in which the injection hole is sealed by the sealing plug.

Another aspect of the present invention pertains to a sealed battery including a battery case provided with the above-mentioned sealing structure; and a positive electrode, a negative electrode, a separator interposed between the positive electrode and the negative electrode, and an electrolyte, which are respectively housed in the battery case.

The sealed battery is preferably a molten salt battery containing, as the electrolyte, a salt having ionic conductivity at least during melting. The following effects are remarkably exerted by applying the sealing structure of the present invention to a molten salt battery whose operating temperature range is higher than those of other batteries.

### Advantageous Effects of Invention

According to the present invention, it becomes possible to maintain, for long periods, a sealing property of the injection hole for injecting an electrolyte into a sealed battery, and it becomes possible to prevent penetration of outside air (water content) into the battery or electrolyte leakage for long periods. As a result of this, the life of the sealed battery can be lengthened and the safety of the sealed battery can be improved. Particularly, such effects are noticeable for a battery which is used under a relatively high-temperature environment like a molten salt battery.

### BRIEF DESCRIPTION OF DRAWINGS

FIG. 1 is a perspective view of a rectangular sealed battery to which a sealing structure of a sealed battery according to an embodiment of the present invention is applied.

FIG. 2 is a front view of a positive electrode of the battery of FIG. 1.

FIG. 3 is a sectional view taken on line II-II of FIG. 2.

FIG. 4 is a front view of a negative electrode of the battery of FIG. 1.

FIG. 5 is a sectional view taken on line IV-IV of FIG. 4.

FIG. 6 is a front view of a sealing plug.

FIG. 7 is an enlarged sectional view of the proximity of an injection hole of a sealing plate immediately before the injection hole is sealed with the sealing plug.

FIG. 8 is an enlarged sectional view of the proximity of an injection hole of a sealing plate at the time when the injection hole is sealed with the sealing plug.

FIG. 9 is a top view of a sealing plate schematically showing an example of a welded part in which a sealing plug is welded to a sealing plate.

FIG. 10 is a top view of a sealing plate schematically showing another example of a welded part in which a sealing plug is welded to a sealing plate.

FIG. 11 is an enlarged sectional view of the proximity of the injection hole of the sealing plate showing a variation of the above-mentioned embodiments.

FIG. 12 is a sectional view showing the appearance of a sealing plug deformed in a state in which an injection hole is sealed with a sealing plug in the above-mentioned variation.

FIG. 13 is an enlarged sectional view of the proximity of the injection hole of the sealing plate showing another variation of the above-mentioned embodiments.

### DESCRIPTION OF EMBODIMENTS

### Outline of Embodiment of Invention

A sealing structure of a sealed battery according to an embodiment of the present invention is a sealing structure for sealing an injection hole through which an electrolyte is injected into the sealed battery. Herein, the sealed battery can comprise a power generating element including a positive electrode, a negative electrode and an electrolyte, and a battery case housing the power generating element and having an aperture. The sealing structure comprises a sealing plate which seals an opening of the battery case and has the injection hole of the electrolyte, and a sealing plug for sealing the injection hole.

The sealing plug has a press-fitted member which includes an elastic material and is press-fitted into the injection hole to block the injection hole, and a plate-shaped holding member for applying pressure to the press-fitted member so that the press-fitted member is held in a state of being press-fitted into the injection hole, the plate-shaped holding member being bonded to the sealing plate. The press-fitted member has a plate-shaped base which has a larger diameter than that of the injection hole and is in contact with the holding member at one principal surface, and a protruding part which is provided so as to protrude from the other principal surface of the base and is inserted into the injection hole.

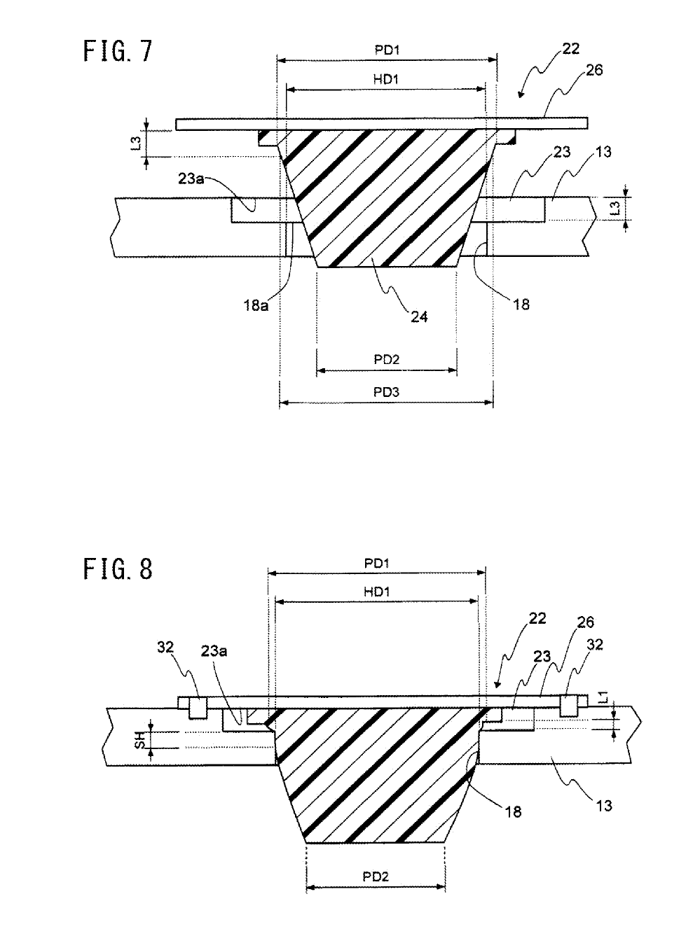

The diameter PD1 of the protruding part at the boundary with the base (refer to FIG. 7) is larger than the diameter HD1 of the holding-member-side (outer side of a battery case) first opening of the injection hole, and the diameter PD2 of the protruding part at the tip portion is smaller than the diameter HD1 of the first opening. Herein, the first opening of the injection hole refers to a boundary line on a holding member-side (outer side of the battery case) of an inner periphery region (sealing part) of the injection hole to be abutted against the protruding part in a state in which the press-fitted member is press-fitted into the injection hole. Further, the diameter of the injection hole can be a uniform diameter equal to the diameter HD1 of the first opening. Then, a gap L1 (refer to FIG. 8) is present between the base and the first opening of the injection hole on the outside of the battery case in a state in which the injection hole is sealed by the sealing plug.

As described above, in the press-fitted member of the sealing plug, a diameter of a root of the protruding part, a principal part of the press-fitted member, is larger than that of the injection hole, and a diameter of a tip portion is smaller than that of the injection hole. As a result of this, the press-fitted member can be formed into a configuration which facilitates insertion of the press-fitted member into the injection hole and can adequately seal the injection hole. Further, in a state in which the injection hole is sealed by the sealing plug (hereinafter, referred to as a sealed state), the protruding part of the press-fitted member is not inserted into the injection hole up to the root (the above-mentioned boundary) of the protruding part, and the gap L1 is present between the base of the press-fitted member and the first opening of the injection hole.

That is, a sealed state in which the injection hole is fully sealed with the sealing plug is already achieved at a stage of partially inserting the protruding part into the injection hole. This facilitates to press-fit the press-fitted member into the injection hole at such an initial compression ratio of the elastic material that sealing performance of the sealing plug can be maintained at a sufficient level for long periods. Further, there is no need to form an injection hole and a press-fitted member with high dimensional precision in order to attain such long-term reliability, and it is possible to easily produce a sealed battery having desired long-term reliability. Further, since a gap of L1 exists between the base of the press-fitted member and the first opening, the press-fitted member can be compressed up to a predetermined compression ratio. Herein, the gap L1, depending on a diameter of the injection hole, is preferably set to, for example, 0.1 to 0.6 mm. Thereby, the above-mentioned effects can be achieved with more reliability.

On the other hand, a ratio (HD1/PD3) of the diameter HD1 of the first opening of the injection hole to a diameter PD3 under an unloaded condition of the protruding part at a first abutted part of the protruding part abutted against the first opening is preferably 0.85 to 0.95. By setting a relationship between two diameters HD1 and PD3 in this way, the compression ratio, 1—HD1/PD3, of the press-fitted member at a sealing part SH of the injection hole (a portion where the press-fitted member is actually in contact with the first opening of the injection hole and its vicinity, refer to FIG. 8) sealed with the press-fitted member, is made appropriate. This facilitates to maintain the sealing performance of the sealing plug at a sufficient level for long periods.

Further, in order to attain desired long-term reliability of the sealing performance, a contact pressure of the sealing part SH is preferably up to 4.5 to 5.5 MPa.

The protruding part is formed into a configuration in which its diameter is continuously reduced so that an angle, which a side face of the protruding part forms with a direction perpendicular to the other principal surface (direction of the normal to the other principal surface) of the base, is 10° to 45°, that is, the side face of the protruding part is tapered, and thereby, it becomes easy to realize a compression ratio as described above. When the side face of the protruding part has a tapered shape within the above-mentioned angle range, it becomes easy to realize the compression ratio of the press-fitted member as described above by adjusting a depth of insertion of the protruding part into the injection hole.

Herein, in order to maintain desired sealing performance for long periods, it is preferred to use an ethylene-propylene-diene rubber or a fluorine-containing rubber as an elastic material contained in the press-fitted member. The ethylene-propylene-diene rubber is preferably one containing at least one selected from the group consisting of ethylidene norbornane, 1,4-hexadiene and dicyclopentadiene, and the content of a diene component is preferably 3.0 to 10.5% by mass. Then, the hardness (durometer A hardness) according to JIS K 6253 of the elastic material is preferably 30 to 80.

Examples of the fluorine-containing rubber include a rubber-like copolymer (FEPM) of tetrafluoroethylene (TFE) and propylene, a rubber-like copolymer (FKM) containing vinylidene fluoride (VDF) as a monomer unit, a rubber-like copolymer (FFKM) of TFE and perfluorovinylether, and the like. Examples of FKM include a VDF-hexafluoropropylene (HFP) copolymer, a VDF-pentafluoropropylene copolymer, a VDF-trifluorochloroethylene copolymer, a VDF-HFP-TFE copolymer, and the like, and any thereof is rubber-like.

Further, the heat resisting temperature (an operating temperature limit within which a continuous operation is feasible) of the elastic material is preferably 90° C. or higher. Moreover, in the elastic material, it is preferred that the compression set after being left for 1000 hours under an ambient temperature of 100° C. is 10% or less. The compression set can be measured by a compression set test according to JIS K 6262, ASTM D395, or ISO 815.

Moreover, it is preferred that at least a step part is formed on an inner periphery of the injection hole so that a diameter of the inner periphery of the injection hole is decreased in a stepwise fashion from the first opening toward a second opening on the side opposite to the first opening. In this case, it is preferred to set a shape and a dimension of the protruding part, and a size of the step part so that a side face of the protruding part is abutted against the above-mentioned at least one step part throughout the entire circumference of the injection hole in a state in which the injection hole is sealed by the sealing plug. Thereby, a sealing part where the protruding part is in close contact with the injection hole can be formed not only in the vicinity of the first opening of the injection hole, but also in the vicinity of the step part. Therefore, the sealing performance of the sealing structure can be improved with more reliability. In addition, also in the sealing part formed in the vicinity of at least one step part, the compression ratio of the press-fitted member (elastic material), and the contact pressure of the sealing part are preferably similar to those of the above-mentioned sealing part in the vicinity of the first opening (compression ratio: 0.05 to 0.15, maximum contact pressure of the sealing part: 4.5 to 5.5 MPa).

Moreover, it is also preferred that the first opening of the injection hole has a chamfered part. Thus, adhesion between the surface of the protruding part deformed due to the compression of the elastic material and the first opening can be enhanced and the above-mentioned effects can be achieved with more reliability.

### Detail of Embodiment of Invention

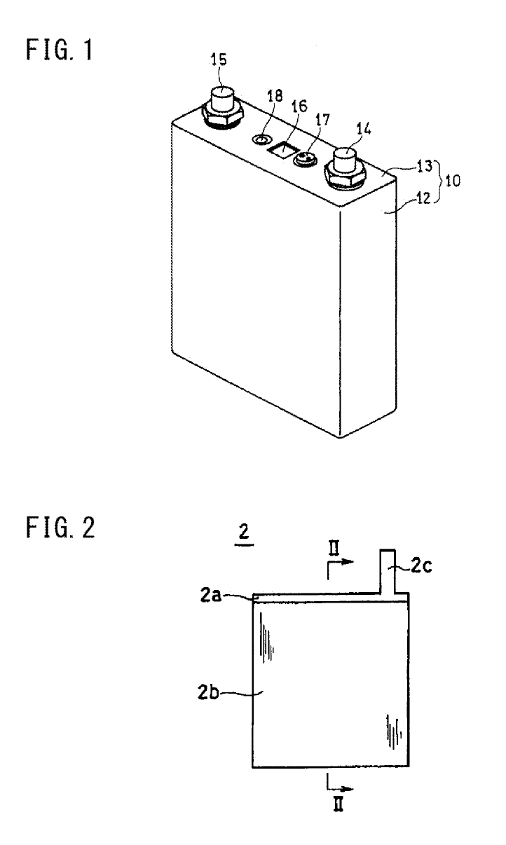

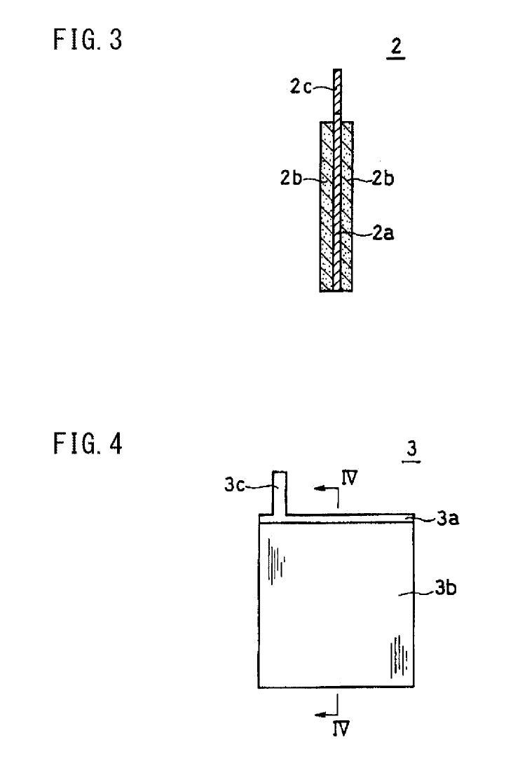

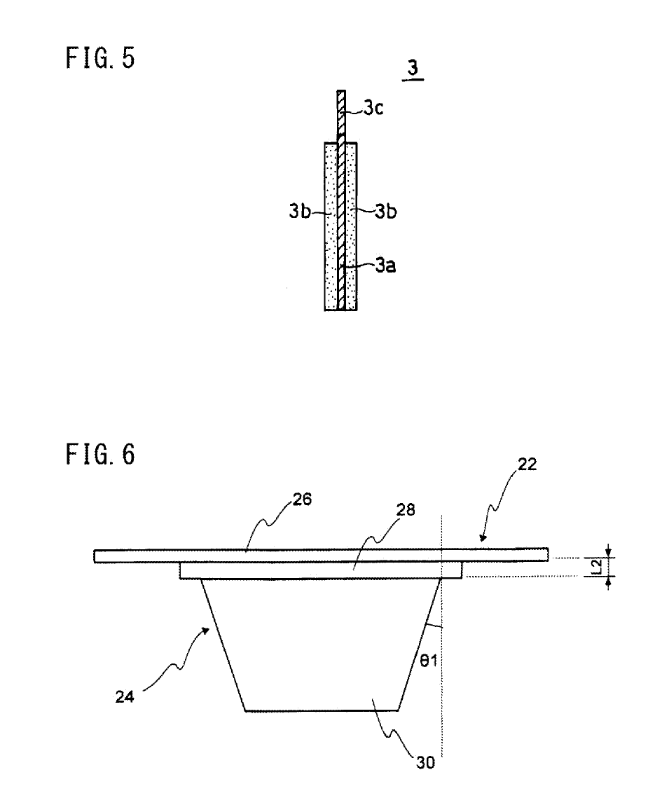

Hereinafter, a sealing structure of a sealed battery according to an embodiment of the present invention will be described in reference with drawings. A schematic constitution of a molten salt battery (battery using a molten salt as an electrolyte) as an example of the sealed battery to which the sealing structure of the present invention is applied is shown in a perspective view in FIG. 1. A schematic constitution of the positive electrode is shown in FIG. 2 and FIG. 3. A schematic constitution of the negative electrode is shown in FIG. 4 and FIG. 5.

A battery 1 illustrated is a rectangular molten salt battery, and includes a laminated electrode group not illustrated, an electrolyte and a rectangular aluminum battery case 10 housing the electrode group and the electrolyte. The electrode group is comprised of a positive electrode 2, a negative electrode 3 and a separator not illustrated, which are laminated in a thickness direction of the battery case 10. The battery case 10 is composed of, for example, a closed-end container main body (case) 12 whose top is opened and a lid (sealing plate) 13 to block the top opening. When the battery 1 is assembled, first, an electrode group is configured and inserted into the container main body 12 of the battery case 10. Thereafter, a step of injecting a molten electrolyte into the container main body 12 to impregnate gaps of a separator, a positive electrode 2 and a negative electrode 3 constituting the electrode group with the electrolyte.

An external positive electrode terminal 14 which penetrates the sealing plate 13 in a state of being electrically continuous with the battery case 10 is provided at a position nearer one side of the sealing plate 13, and an external negative electrode terminal 15 which penetrates the sealing plate 13 in a state of being insulated from the battery case 10 is provided at a position nearer the other side of the sealing plate 13. A safety valve (rupture valve) 16 for releasing a gas internally generated when an internal pressure of the battery case 10 rises rapidly is provided at the center of the sealing plate 13. A pressure-regulating valve 17, which discharges a gas internally generated to the outside when an internal pressure of the battery case 10 rises gradually, is provided at a position nearer the external positive electrode terminal 14 in relation to the rupture valve 16 of the sealing plate 13.

Further, in a battery 1 illustrated, an injection hole 18 is provided at a position nearer the external negative electrode terminal 15 in relation to the safety valve 16 of the sealing plate 13. The injection hole 18 is a hole for injecting an electrolyte into the inside of the battery case 10 after a power generating element (electrode group and electrolyte) is inserted into the inside of the container main body 12 and the sealing plate 13 is welded to the opening of the container main body 12. The injection hole 18 is sealed with a sealing plug 22 shown in FIG. 6 or the like after completion of injection of the electrolyte into the battery case 10. Further, the sealing structure includes at least an inner periphery and an opening of the injection hole 18, and the sealing plug 22. In addition, FIG. 1 shows a state in which the injection hole 18 is opened.

The positive electrode 2 and the negative electrode 3 respectively constituting the laminated electrode group are both in the form of a rectangular sheet as shown in FIG. 2 to FIG. 5. The laminated electrode group is comprised of a plurality of positive electrodes 2, a plurality of negative electrodes 3 and a plurality of separators interposed therebetween. The plurality of positive electrodes 2 and the plurality of negative electrodes 3 are alternately arranged in a lamination direction within the electrode group.

A positive electrode lead piece 2c may be formed at one end of each positive electrode 2. The plurality of positive electrodes 2 are connected in parallel by tying positive electrode lead pieces 2c of the plurality of positive electrodes 2 in a bundle and connecting the bundle to the external positive electrode terminal 14 provided on the sealing plate 13 of the battery case 10. Similarly, a negative electrode lead piece 3c may be formed at one end of each negative electrode 3. The plurality of negative electrodes 3 are connected in parallel by tying negative electrode lead pieces 3c of the plurality of negative electrodes 3 in a bundle and connecting the bundle to the external negative electrode terminal 15 provided on the sealing plate 13 of the battery case 10. It is desirable to arrange the bundle of the positive electrode lead pieces 2c and the bundle of the negative electrode lead pieces 3c at intervals in a horizontal direction on one end face of the electrode group to avoid contact with each other.

[Positive Electrode]

The positive electrode 2 contains a positive electrode current collector 2a and a positive electrode active material layer 2b fixed to the positive electrode current collector 2a. The positive electrode active material layer 2b contains a positive electrode active material as an essential component and may contain a binder, a conducting agent and the like as an optional component.

As the positive electrode current collector 2a, a metal foil, a nonwoven fabric made of metallic fibers, a metal porous body sheet or the like is used. The metal constituting the positive electrode current collector is preferably aluminum, an aluminum alloy or the like since they are stable at a positive electrode potential; however, the metal is not particularly limited. The thickness of the metal foil serving as a positive electrode current collector is, for example, 10 to 50 μm, and the thickness of the nonwoven fabric made of metallic fibers or the metal porous body sheet is, for example, 100 to 600 μm. The lead piece 2c for collecting a current may be formed integrally with the positive electrode current collector, as shown in FIG. 2, or a lead piece separately formed may be connected to the positive electrode current collector by welding.

As the positive electrode active material, a sodium-containing transition metal compound is preferably used from the viewpoint of thermal stability or electrochemical stability. As the sodium-containing transition metal compound, a compound having a layered structure in which sodium can be extracted/inserted from or into an interlayer, but not particularly limited to this, is preferred.

The sodium-containing transition metal compound is preferably at least one selected from the group consisting of, for example, sodium chromite (NaCrO₂, etc.) and iron substituted sodium manganate (Na_{2/3}Fe_{1/3}Mn_{2/3}O₂, etc.). Further, a part of Cr or Na of sodium chromite may be replaced with another element, and a part of Fe, Mn or Na of iron substituted sodium manganate may be replaced with another element.

The binder plays a role in binding the positive electrode active materials to one another and fixing the positive electrode active material to the positive electrode current collector. As the binder, a fluorine resin, polyamide, polyimide, polyamide imide and the like can be used.

Examples of the conducting agent to be contained in the positive electrode include graphite, carbon black, carbon fiber and like. Among these, carbon black is particularly preferred since a small amount of carbon black can easily form a sufficient conductive path.

[Negative Electrode]

The negative electrode 3 contains a negative electrode current collector 3a and a negative electrode active material layer 3b fixed to the negative electrode current collector 3a. For the negative electrode active material layer 3b, for example, sodium, sodium alloy or metal capable of being alloyed with sodium can be used. Such a negative electrode includes a negative electrode current collector formed of, for example, a first metal, and a second metal covering at least a part of the surface of the negative electrode current collector. Herein, the first metal is a metal which is not alloyed with sodium, and the second metal is a metal which is alloyed with sodium.

As the negative electrode current collector formed of the first metal, a metal foil, a nonwoven fabric made of metallic fibers, a metal porous body sheet or the like is used. As the first metal, aluminum, an aluminum alloy, copper, a copper alloy, nickel, a nickel alloy and the like are preferred since they are not alloyed with sodium and are stable at a negative electrode potential.

Examples of the second metal include zinc, a zinc alloy, tin, a tin alloy, silicon, a silicon alloy and the like. Among these metals, zinc and the zinc alloy are preferred in that they have good wettability to a molten salt. A thickness of the negative electrode active material layer formed of the second metal is suitably, for example, 0.05 to 1 μm.

Further, the negative electrode active material layer 3b contains a negative electrode active material as an essential component and may be a mixture layer containing a binder, a conducting agent and the like as an optional component. Materials exemplified as a constituent of the positive electrode can also be used as a binder and a conducting agent to be used for the negative electrode.

As the negative electrode active material constituting a negative electrode mixture layer, a sodium-containing titanium compound, a non-graphitizable carbon (hard carbon) or the like is preferably used from the viewpoint of thermal stability or electrochemical stability. As the sodium-containing titanium compound, sodium titanate is preferably used, and more specifically, at least one selected from the group consisting of Na₂Ti₃O₇ and Na₄Ti₅O₁₂ is preferably used. Further, a part of Ti or Na of sodium titanate may be replaced with another element.

The non-graphitizable carbon is a carbon material in which a graphite structure does not grow even though the carbon material is heated in an inert atmosphere, and refers to a material which contains minute graphite crystals arranged in a random direction and has gaps on the order of nanometer between crystal layers. Since a diameter of a sodium ion, typical alkali metal, is 0.95 angstrom, a space of the gap is preferably much larger than 0.95 angstrom.

[Electrolyte (Molten Salt)]

The electrolyte contains at least a salt containing, as cations, sodium ions serving as a carrier of electric charge in the molten salt battery. As such a salt, for example, a compound represented by N(SO₂X¹)(SO₂X²).M (X¹ and X² are independently a fluorine atom or a fluoroalkyl group having 1 to 8 carbon atoms and M represents an alkali metal or an organic cation having a nitrogen-containing heterocycle) can be used. In this case, N(SO₂X¹)(SO₂X²).M contains at least N(SO₂X¹)(SO₂X²).Na.

In the fluoroalkyl group represented by X¹ and X², a part of hydrogen atoms of the alkali metal may be replaced with fluorine atoms, or the fluoroalkyl group may be a perfluoroalkyl group in which all hydrogen atoms are replaced with fluorine atoms. At least one of X¹ and X² is preferably a perfluoroalkyl group, and both of X¹ and X² are more preferably a perfluoroalkyl group from the viewpoint of reducing viscosity of the molten salt. By setting the number of carbon atoms to 1 to 8, it is possible to suppress an increase of a melting point of the electrolyte and it has advantage to obtain a molten salt with low viscosity. Particularly, from the viewpoint of obtaining an ionic liquid with low viscosity, the number of carbon atoms of a perfluoroalkyl group is preferably 1 to 3, and more preferably 1 to 2. Specifically, X¹ and X² may be independently a trifluoromethyl group, a pentafluoroethyl group or a heptafluoropropyl group.

Specific examples of bissulfonylamide anion represented by N(SO₂X¹)(SO₂X²) include bis(fluorosulfonyl)amide anion (FSA.); bis(trifluoromethylsulfonyl)amide anion (TFSA.), bis(pentafluoroethylsulfonyl)amide anion, fluorosulfonyl(trifluoromethylsulfonylamide) anion (N(FSO₂)(CF₃SO₂)) and the like.

Examples of alkali metals represented by M other than sodium include potassium, lithium, rubidium and cesium. Among these metals, potassium is preferred.

As the organic cation which is represented by M and has a nitrogen-containing heterocycle, cations having a pyrrolidinium skeleton, an imidazolium skeleton, a pyridinium skeleton, a piperidinium skeleton or the like can be used. Among these cations, a cation having a pyrrolidinium skeleton is preferred since it can form a molten salt with a low melting point and is stable even at high-temperatures.

The organic cation having a pyrrolidinium skeleton is represented, for example, by the general formula (1):

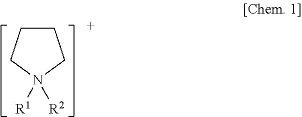

In the above formula, R¹ and R² are independently an alkyl group having 1 to 8 carbon atoms. By setting the number of carbon atoms to 1 to 8, it is possible to suppress an increase of a melting point of the electrolyte and it has advantage to obtain an ionic liquid with low viscosity. Particularly, from the viewpoint of obtaining an ionic liquid with low viscosity, the number of carbon atoms of the alkyl group is preferably 1 to 3, and more preferably 1 to 2. Specifically, R¹ and R² may be independently a methyl group, an ethyl group, a propyl group or an isopropyl group.

Specific examples of the organic cation having a pyrrolidinium skeleton include a methylpropylpyrrolidinium cation, an ethylpropylpyrrolidinium cation, a methylethylpyrrolidinium cation, a dimethylpyrrolidinium cation, a diethylpyrrolidinium cation and the like. These cations may be used singly or may be used in combination of two or more thereof. Among these cations, the methylpropylpyrrolidinium cation (Py13³⁰ ) is particularly preferred because of high thermal stability and high electrochemical stability.

Specific examples of the molten salt include a salt of a sodium ion and FSA.(NaFSA), a salt of a sodium ion and TFSA.(NaTFSA), a salt of Py13⁺ and FSA.(Py13FSA), a salt of Py13+ and TFSA.(Py13TFSA) and the like.

The melting point of the molten salt is preferably lower. It is preferred to use a mixture of two or more salts from the viewpoint of lowering the melting point of the molten salt. For example, when the first salt of sodium and a bissulfonylamide anion is used, the first salt is preferably used in combination with the second salt of a cation other than sodium and a bissulfonylamide anion. The bissulfonylimide anions for forming the first salt and the second salt may be the same or different.

A potassium ion, a cesium ion, a lithium ion, a magnesium ion, a calcium ion, and the above-mentioned organic cations can be used for the cation other than sodium. The cations other than sodium may be used singly, or may be used in combination of two or more thereof.

When NaFSA or NaTFSA is used as the first salt, a salt of a potassium ion and FSA.(KFSA), a salt of a potassium ion and TFSA.(KTFSA) and the like are preferably used as the second salt. More specifically, a mixture of NaFSA and KFSA or a mixture of NaTFSA and KTFSA is preferably used. In this case, in consideration of a balance among a melting point, viscosity and ionic conductivity of the electrolyte, a molar ratio (first salt/second salt) of the first salt to the second salt is, for example, 40/60 to 70/30, preferably 45/55 to 65/35, and more preferably 50/50 to 60/40.

When a salt of Py13 is used as the first salt, such a salt has a low melting point and is low in viscosity even at ordinary temperature. However, when a sodium salt, a potassium salt or the like is used in combination as the second salt, the melting point of the salt becomes lower. When Py13FSA or Py13TFSA is used as the first salt, NaFSA, NaTFSA and the like are preferably used as the second salt. More specifically, a mixture of Py13FSA and NaFSA or a mixture of Py13TFSA and NaTFSA is preferably used. In this case, in consideration of a balance among a melting point, viscosity and ionic conductivity of the electrolyte, a molar ratio (first salt/second salt) of the first salt to the second salt is, for example, 97/3 to 80/20, and preferably 95/5 to 85/15.

The electrolyte may contain various additives in addition to the above-mentioned salts. However, the above-mentioned molten salt preferably constitutes 90 to 100% by mass, further 95 to 100% by mass of the electrolyte filled into a battery from the viewpoint of ensuring the ionic conductivity and the thermal stability.

[Separator]

While a material of the separator may be selected in consideration of an operating temperature of the battery, glass fibers, silica-containing polyolefin, a fluorine resin, alumina, polyphenylene sulfide (PPS) or the like is preferably used from the viewpoint of suppressing a side reaction of the separator with the electrolyte.

Details on the sealing plug is shown in a front view in FIG. 6. A state, which occurs immediately before the injection hole of the sealing plate is sealed with the sealing plug, is shown in an enlarged sectional view in FIG. 7.

As shown in FIG. 6, the sealing plug 22 has a press-fitted member 24 which includes an elastic material and is press-fitted into the injection hole 18 to block the injection hole 18, and a plate-shaped holding member 26 made of metal. The press-fitted member 24 includes a plate-shaped base 28 which is bonded to the holding member 26 at one principal surface, and a protruding part 30 which is provided so as to protrude from the other principal surface of the base 28 and is inserted into the injection hole 18. The holding member 26 is joined to the sealing plate 13, for example, by welding, and applies pressure to the press-fitted member 24 so that the press-fitted member 24 is held in a state of being press-fitted into the injection hole 18. The holding member 26 made of metal prevents the electrolyte from permeating the press-fitted member 24 to leak out of the battery. Further, the base 28 and the protruding part 30 can be formed by integrally molding an elastic material. A thickness of the base 28 is represented by a character L2.

The injection hole 18 is a hole provided so as to penetrate the sealing plate 13 in a thickness direction, and a step-like deep counterbore part 23 for facilitating injection of the electrolyte and for housing the base 28 of the press-fitted member 24 is formed at a position on a front side (an outer side of the battery case 10) of the sealing plate 13 corresponding to the injection hole 18. The depth L3 of the deep counterbore part 23 is made larger than the thickness L2 of the base 28 (L3>L2). The injection hole 18 is opened through the first opening 18a at a center of a bottom of the deep counterbore part 23. A diameter of the holding member 26 is made larger than a diameter of an opening 23a of the deep counterbore part 23, and a peripheral part of the holding member 26 is abutted against the front surface of the sealing plate 13 around the opening 23a of the deep counterbore part 23.

On the other hand, the protruding part 30 of the press-fitted member 24 is circular at the boundary with the base 28, and the diameter PD1 at the boundary is made larger than the diameter HD1 of the first opening 18a of the injection hole 18. A tip portion of the protruding part 30 has a circular flat surface, and the diameter PD2 of the tip portion is made smaller than the diameter HD1 of the first opening 18a. Accordingly, the diameter PD1 at the boundary is larger than the diameter PD2 at the tip portion.

In the protruding part 30, the side face is uniformly inclined so that a diameter of the protruding part is continuously reduced from the above boundary toward the tip portion. That is, the side face of the protruding part 30 is formed into a tapered shape. Herein, an angle θ1, which the side face of the protruding part 30 forms with a direction of the normal to one principal surface (a principal surface on a lower side in FIG. 6) of the plate-like base 28, can be set to 10° to 45°.

FIG. 8 shows a state (sealed state) in which the injection hole is sealed by the sealing plug. In the sealed state, a peripheral part of the holding member 26 is joined to the front surface of the sealing plate 13, for example, by welding. In this time, the protruding part 30 of the press-fitted member 24 is press-fitted into the injection hole 18 at a position a distance L1 from the base 28 so that the compression ratio, 1—HD1/PD3, is in the range of 0.05 to 0.15. However, PD3 is a diameter of the protruding part 30 at a portion to be abutted against the first opening 18a in the sealed state. In this situation, the base 28 is separated from the first opening 18a (or a bottom of the deep counterbore part 23) by a gap L1. In the above, L1=L3−L2.

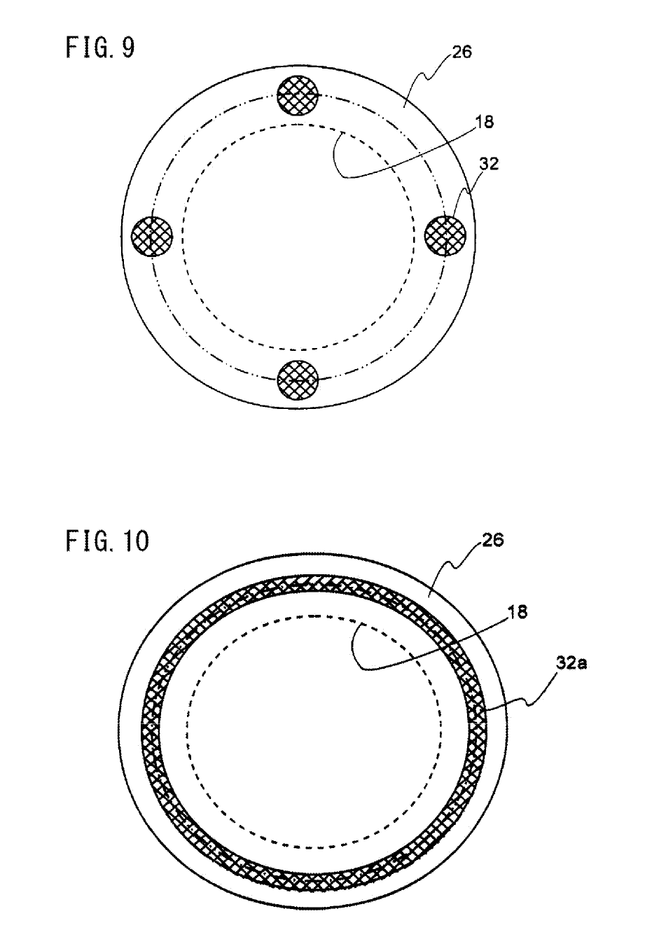

Herein, as shown in FIG. 9, the holding member 26 can be welded to the sealing plate 13 by forming a plurality of welded portions 32 so as to be concentrically located with respect to the first opening 18a by spot resistance welding. Alternatively, as shown in FIG. 10, the holding member 26 can be welded to the sealing plate 13 by forming one continuous welded portion 32a concentrically with respect to the first opening 18a, for example, by laser welding. As shown in FIG. 10, by forming the continuous welded portion 32a so as to surround the first opening 18a, it is possible to prevent the electrolyte from leaking out of the battery through the injection hole 18 with more reliability.

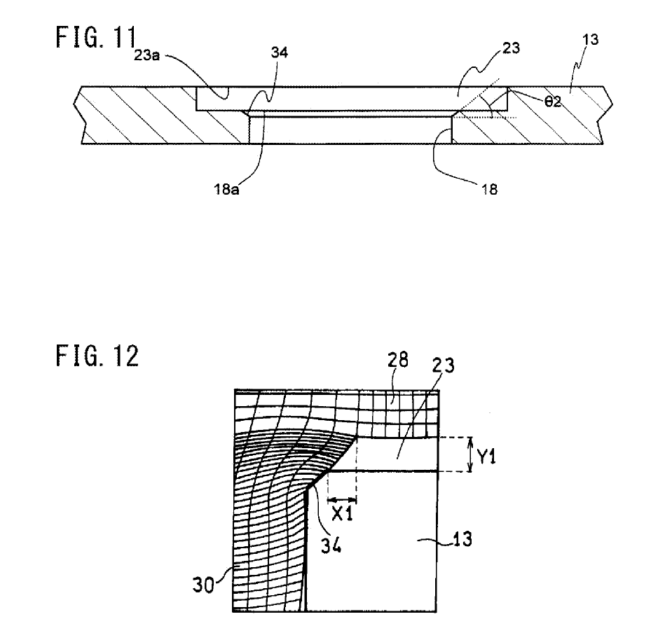

A variation of the present embodiment is shown in FIG. 11. In the variation shown in FIG. 11, a chamfered part 34 is formed in the first opening 18a of the injection hole 18. By providing the chamfered part 34 in the first opening 18a, as shown in an enlarged sectional view in FIG. 12, it is possible to increase a contact area between the surface of the protruding part 30 deformed through press-fitting into the injection hole 18 and the edge of the first opening 18a to improve airtightness therebetween. In addition, when the chamfered part 34 is provided, a boundary (line of intersection of the chamfered part 34 and a bottom part of the deep counterbore part 23) of a top end of the chamfered part 34 is the first opening 18a, and a diameter of the injection hole 18 is slightly smaller than a diameter HD1 of the first opening 18a.

An inclination angle (inclination relative to a bottom of the counterbore part 23) θ2 of the chamfered part 34 is preferably set in accordance with a ratio (Y1/X1) between a vertical distance Y1 (Y1=L1) and a horizontal distance X1 between an outer rim of a boundary between the protruding part 30 and the base 28 and an outer rim of the first opening 18a. Assuming α=tan θ2/(Y1/X1), it is preferred to set an angle θ2 so as to satisfy 0.8≦α≦1.2. By setting a relationship between the angle θ2 and the ratio (Y1/X1) in this way, it is possible to more increase a contact area and a contact pressure between the surface of the protruding part 30 and the edge of the first opening 18a to more improve airtightness therebetween.

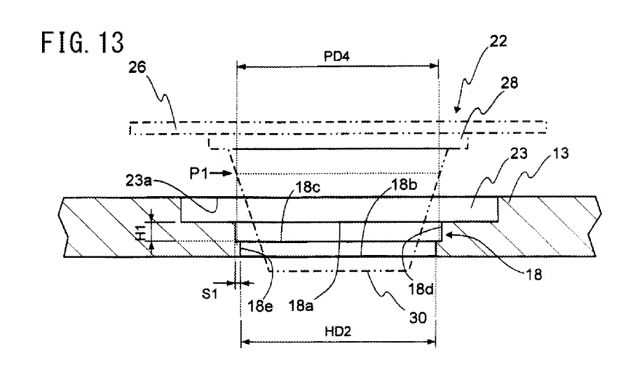

Another variation of the present embodiment is shown in FIG. 13. In the variation shown in FIG. 13, a step part 18c is formed at a position at a depth of H1 from the first opening 18a of the injection hole 18. The number of step parts 18c is not limited and may be 2 or more. A portion on a side of the first opening 18a in relation to the step part 18c of the injection hole 18 forms a large diameter part 18d having a diameter equal to that of the first opening 18a. A diameter of the injection hole 18 is decreased in a stepwise fashion toward a second opening 18b which is an opening on the side opposite to the first opening 18a (an inner opening in the case) by the presence of the step part 18c, and a diameter of a small diameter part 18e is equal to a diameter HD2 of the second opening 18b.

Further, a diameter PD4 of a portion (P1) of the protruding part 30 corresponding to the step part 18c in a sealed state is made larger than a diameter HD2 of the second opening 18b. Consequently, a portion of the protruding part 30 corresponding to the step part 18c is abutted against the inner periphery of the injection hole 18 throughout its entire circumference. At this time, it is preferred to set a step part position (H1) and a step part width S1 (in an illustrated example, S1=[(HD2−HD1)/2]) so that a compression ratio of the portion of the protruding part 30 corresponding to the step part 18c, (PD4−HD2)/PD4=1−HD2/PD4, is nearly equal to the compression ratio (1—HD1/PD3) of the protruding part 30 at the first opening 18a.

By forming at least a step part on the inner periphery of the injection hole 18 as described above, a diameter of the injection hole 18 is decreased in a stepwise fashion from the first opening 18a toward the second opening 18b, and therefore it is possible to bring the protruding part 30 into contact with the injection hole 18 at a relatively large pressure also at a side face close to a tip portion of the protruding part 30. Consequently, a sealing property of the injection hole 18 with the sealing plug 22 can be improved. In addition, also in the variation of FIG. 13, a chamfered part similar to that in the variation of FIG. 11 can be provided in at least one of the first opening 18a and the step part 18c.

The above embodiments (including variations) are intended to illustrate the invention in all respects and are not to be construed to limit the invention. The scope of the invention is defined by the appended claims rather than by the above-mentioned embodiments, and all modifications which fall within the scope of the claims, or equivalence of the scope of the claims are therefore intended to be embraced by the claims.

### INDUSTRIAL APPLICABILITY

According to the present invention, since the sealing performance of the injection hole of the sealed battery can be maintained at a sufficient level for long periods, the safety of the sealed battery can be improved and the life of the battery can be lengthened. Particularly, such effects are noticeable for the sealed battery which is often used under a high-temperature environment like a molten salt electrolyte battery.

### REFERENCE SIGNS LIST

1: SEALED BATTERY

12: CONTAINER MAIN BODY (BATTERY CASE)

13: SEALING PLATE

18: INJECTION HOLE

18a: FIRST OPENING

18c: STEP PART

22: SEALING PLUG

24: PRESS-FITTED MEMBER

26: HOLDING MEMBER

28: BASE

30: PROTRUDING PART

34: CHAMFERED PART

32, 32a: WELDED PART

1. A sealing structure of a sealed battery for sealing an injection hole through which an electrolyte is injected into the sealed battery,
the sealing structure comprising a sealing plate having the injection hole, and a sealing plug for sealing the injection hole,
wherein the sealing plug has:
a press-fitted member including an elastic material and press-fitted into the injection hole to block the injection hole; and
a plate-shaped holding member for applying pressure to the press-fitted member so that the press-fitted member is held in a state of being press-fitted into the injection hole, the plate-shaped holding member being bonded to the sealing plate, and
wherein the press-fitted member has a plate-shaped base having a larger diameter than that of the injection hole, the plate-shaped base being in contact with the holding member at one principal surface; and a protruding part provided so as to protrude from the other principal surface of the base, the protruding part being inserted into the injection hole,
the diameter PD1 of the protruding part at the boundary with the base is greater than the diameter HD1 of the holding-member-side first opening of the injection hole, and the diameter PD2 of the protruding part at the tip portion is less than the diameter HD1,
a gap L1 is provided between the base and the first opening of the injection hole in a state in which the injection hole is sealed by the sealing plug,
a step part is formed on an inner periphery in the injection hole so as to form a large diameter part on the first opening side and form a small diameter part on a side of the second opening opposite to the first opening, and
in a state in which the injection hole is sealed by the sealing plug,
the large diameter part and the small diameter part are respectively abutted against a side face of the protruding part so as to compress the protruding part.

2. The sealing structure of a sealed battery according to claim 1, wherein a ratio (HD1/PD3) of the diameter HD1 to a diameter PD3 under an unloaded condition of the protruding part at a first abutted part of the protruding part abutted against the first opening of the injection hole is 0.85 to 0.95.

3. The sealing structure of a sealed battery according to claim 1, wherein a diameter of the protruding part is continuously reduced so that an angle which the side face forms with a direction perpendicular to the other principal surface of the base is 10° to 45°.

4. The sealing structure of a sealed battery according to claim 1,
wherein the elastic material contains an ethylene-propylene-diene rubber or a fluorine-containing rubber,
the ethylene-propylene-diene rubber contains at least one selected from the group consisting of ethylidene norbornane, 1,4-hexadiene and dicyclopentadiene, and
the hardness (durometer A hardness) according to JIS K 6253 of the elastic material is 30 to 80.

5. (canceled)

6. The sealing structure of a sealed battery according to claim 1, wherein the first opening of the injection hole has a chamfered part.

7. The sealing structure of a sealed battery according to claim 1, wherein the sealed battery uses a molten salt as the electrolyte.

8. A sealed battery comprising:
a battery case provided with the sealing structure according to claim 1; and
a positive electrode, a negative electrode, a separator interposed between the positive electrode and the negative electrode, and an electrolyte, which are respectively housed in the battery case.

9. The sealed battery according to claim 8, wherein the sealed battery is a molten salt battery containing, as the electrolyte, a salt having ionic conductivity at least during melting.
